(19) United States
(12) Patent Application Publication
(10) Pub. No.: US 2005/0083493 A1
(43) Pub. Date: Apr. 21, 2005

(54) Electric lamp, and light projector provided with an electric lamp

(76) Inventors: Johannes Petrus Maria Ansems, Eindhoven (NL); Jean-Francois Lavaud, Bergerac (FR); Stefan Marcus Verbrugh, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,289

(22) PCT Filed: Feb. 25, 2003
(86) PCT No.: PCT/IB03/00732

(30) Foreign Application Priority Data
Mar. 5, 2002 (EP) 022905426

(51) Int. Cl. G03B 21/28

(52) U.S. Cl. 353/98

(57) ABSTRACT

An electric lamp (1) comprising an elliptical reflector body (3) with a light emission window (5) and with a light-transmitting cover (11) positioned in the light emission window. A light chamber (7) is defined by the reflector body, in which chamber a light source (13) is positioned in a first focus (F1) of the reflector body. A second focus (F2) of the reflector body is located outside the light chamber and at an end (19) of an optical waveguide (17). The cover is provided with IR-reflecting means (15) and is parabolically or elliptically shaped, the cover having a focus (Flid) which is located on the light source.

The invention relates to an electric lamp comprising:
an elliptical reflector body comprising a light emission window and surrounding a light chamber, and having a first focus in the light chamber and a second focus outside the light chamber,
a reflector coating provided on the reflector body, which coating reflects visible light;
a light-transmitting cover connected to the reflector body at the area of the light emission window;
a light source arranged in the light chamber in the location of the first focus.

The invention also relates to a light projector.

Such an electric lamp is known from U.S. Pat. No. 4,041,344. The known lamp is suitable for coupling light, originating from the light source and reflected in a desired direction by the reflector coating, into an end of an optical waveguide, such as an optical fiber, which is manufactured, for example, from synthetic resin. The end of the fiber is for this purpose located in the second focus of the elliptical reflector. It is achieved thereby that radiation originating from a comparatively large light source can be coupled into the optical waveguide and can thus be concentrated into a comparatively narrow light beam of comparatively high intensity. It is a disadvantage of the known electric lamp that this method of coupling gives the optical waveguide a high degree of heating at its end because of the high intensity obtained, which thus leads to a comparatively high risk of deformation and/or loss of its comparatively favorable coupling and wave-guiding properties.

The invention has for its object to counteract the above disadvantage. For this purpose, the electric lamp of the kind described in the opening paragraph is characterized in that the light-transmitting cover is provided with means for blocking infrared (IR) radiation. Heating-up of the optical waveguide is caused in particular by infrared radiation which is generated in addition to visible light by the light source during operation of the light source. The means for excluding IR radiation counteract that this IR radiation is coupled into the optical waveguide. It is achieved thereby that the optical waveguide is heated to a substantially lesser degree. The means for excluding IR radiation may be, for example, a glass which absorbs IR radiation and from which the cover is manufactured. Alternatively, the means for excluding IR radiation may comprise an infrared-reflecting coating, for example a dichroic coating. The coating may be an interference coating which is mirroring and which is built up from alternating layers of comparatively high and comparatively low refractive index, for example titanium dioxide and silicon dioxide, respectively. It can be achieved in a simple manner thereby that the IR radiation is displaced towards a desired location by reflection, for example towards the light source. To achieve this, the cover of a favorable embodiment of the electric lamp is elliptically or parabolically curved. Preferably, the elliptically curved cover has two focuses in the electric lamp, each being located on the light source. Not only does this counteract the undesirable heating of the optical waveguide, it also achieves that the reflected IR radiation is usefully employed for heating the light source. A comparatively efficient operation of the light source is thus achieved. A similar argument holds for a parabolically curved cover, of which a focus is located on the light source.

In an alternative embodiment, the cover is not only infrared-excluding, but in addition red or amber in color. Such a colored cover makes it possible to use the electric lamp in vehicles, for example automobiles, for example as a brake light and/or indicator light. The red or amber color of the cover may be achieved by means of a red or amber coating, but it is alternatively possible for the cover to be manufactured from a red or amber material.

In a favorable embodiment, the reflector coating transmits infrared radiation. Such a property of the reflector coating can be realized in a comparatively simple manner, for example by the use of a dichroic coating as the reflector coating, and has the advantage that the heat of the light source is guided away from the optical waveguide. The reflector coating may be provided either on an inner surface or on an outer surface of the reflector body.

The light source may be a filament, while the light chamber is gastight and filled with an inert gas, which gas may or may not comprise a halogen. A filament used in this manner has the advantage that light originating from the light source is free from disturbances in the optical path of the light such as may occur when a filament is used in a separate bulb.

Alternatively, the light source may comprise a separate discharge bulb in which a pair of electrodes is positioned one opposite the other, thus defining a discharge path. The discharge path in that case is located in the first focus of the reflector in the light chamber. It is alternatively possible for the light source to comprise a separate, gastight bulb with a filament therein, which filament is located in the first focus of the reflector body in the light chamber. A separate bulb has the advantage that, in the case of failure of the light source, it suffices to replace the bulb and the light source in a comparatively simple manner so as to make the electric lamp operational again.

An embodiment of the electric lamp according to the invention will be explained in more detail with reference to the diagrammatic drawing in which:

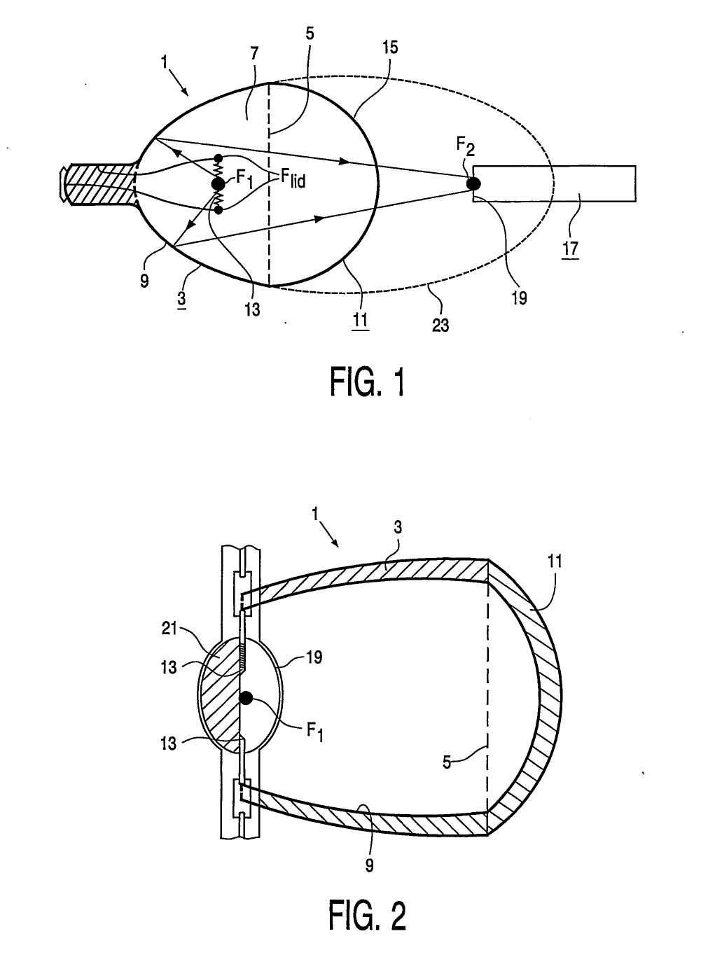

FIG. 1 is a cross-sectional view of a first embodiment of an electric lamp according to the invention, and

FIG. 2 is a cross-sectional view of a second embodiment of an electric lamp according to the invention.

FIG. 1 is a cross-sectional view of an electric lamp (1) comprising an elliptical reflector body (3) with a light emission window (5) and surrounding a light chamber (7). An ellipse (23) is shown with a dotted line, and it is indicated that the reflector body coincides with part of this ellipse. The reflector body has a first focus (F1) in the light chamber and a second focus (F2) outside the light chamber. A reflector coating (9) which reflects visible light is provided on an outer side of the reflector body. A light-transmitting cover (11) is connected to the reflector body at the area of the light emission window, closing off the light chamber in a gastight manner. A light source (13), a filament in the Figure, is arranged in the light chamber in the location of the first focus. The light-transmitting cover is provided with means (15) for excluding infrared radiation, a dichroic coating in the Figure built up from alternating layers of titanium dioxide and silicon dioxide. FIG. 1 also shows an optical waveguide (17) which is positioned with one end (19) in the second focus (F2) of the reflector body. The cover has an elliptically curved shape with two focuses Flid which are located on the filament. Infrared radiation incident on the cover is accordingly reflected by the cover onto the filament.

FIG. 2 is a cross-sectional view of a second embodiment of an electric lamp (1) according to the invention. The light source (13) in the Figure is a gas discharge lamp, i.e. a pair of electrodes surrounded by a bulb (19) and positioned such that the first focus (F1) of the reflector body (3) lies between the electrodes forming the electrode pair. To counteract light losses, the bulb is partly provided with a light-reflecting coating (21). A light-transmitting cover (11) is connected to the reflector body at the area of the light emission window (5) and is manufactured from an amber-colored glass and is provided with means for excluding infrared radiation. The reflector body is provided with a reflector coating (9) on an inner surface, which coating reflects visible light and transmits infrared radiation.

1. An electric lamp (1) comprising:
an elliptical reflector body (3) comprising a light emission window (5) and surrounding a light chamber (7), and having a first focus (F1) in the light chamber and a second focus (F2) outside the light chamber,
a reflector coating (9) provided on the reflector body, which coating reflects visible light;
a light-transmitting cover (11) connected to the reflector body at the area of the light emission window;
a light source (13) arranged in the light chamber in the location of the first focus,
characterized in that the light-transmitting cover is provided with means (15) for blocking infrared (IR) radiation.

2. An electric lamp as claimed in claim 1, characterized in that the means for excluding infrared radiation comprise an infrared-reflecting coating.

3. An electric lamp as claimed in claim 1, characterized in that the cover is red or amber in color.

4. An electric lamp as claimed in claim 2, characterized in that the reflector coating transmits infrared radiation.

5. An electric lamp as claimed in claim 1, characterized in that the cover is an elliptically or parabolically curved cover.

6. An electric lamp as claimed in claim 5, characterized in that the cover is elliptically curved and has two focuses (F_{lid}), each focus being located on the light source.

7. An electric lamp as claimed in claim 5, characterized in that the cover is parabolically curved and has a focus (F_{lid}) which is located on the light source.

8. A light projector comprising an electric lamp (1) as claimed in claim 1, and an optical fiber (17) whose end (19) is located in the second focus (F2) of the elliptical reflector (3).
